(19) United States
(12) Patent Application Publication
(10) Pub. No.: US 2006/0112602 A1
(43) Pub. Date: Jun. 1, 2006

(54) Advertising products using traffic icons

(76) Inventor: Martin Malek, Brooklyn, NY (US)

Correspondence Address: GOTTLIEB RACKMAN & REISMAN PC, 270 MADISON AVENUE, 8TH FLOOR, NEW YORK, NY, 100160601, US

(21) Appl. No.: 11/273,762

(22) Filed: Nov. 14, 2005

Related U.S. Application Data
(60) Provisional application No. 60/626,904, filed on Nov. 11, 2004.

(51) Int. Cl. G09F 13/22

(52) U.S. Cl. 40/544

(57) ABSTRACT

A novel concept of using standard or modified traffic signs or icons for advertising purposes is provided. Symbols or graphics are added to or superimposed on the icons to create an effective advertisement for consumer products and services. Viewers of the signs are likely to respond positively to such advertisements due to the easily recognizable nature of traffic signs the viewers can associate with, and the semantic association provided by the traffic signs with activities.

### RELATED APPLICATIONS

This application claims priority to U.S. provisional application Ser. No. 60/626,904 filed Nov. 11, 2004 and incorporated herein by reference.

### BACKGROUND OF THE INVENTION

A. Field of Invention

This invention relates to using standard or modified traffic icons for advertising consumer products and services.

B. Description of the Prior Art

Traffic signs are used to control traffic flow of both motor vehicles and pedestrians. Early traffic signs consisted of flags, colored lights or signs including words, such as “WALK” and “STOP.” These types of signs were somewhat confusing for certain types of persons, including visitors and tourists who were not familiar with the signs. The signs with words caused special problems because they confused persons who either could not read (e.g., children, or persons with mental disabilities) or who spoke other languages.

In order to overcome these problems, federal and local authorities are promulgating the use of several traffic signs, including icons used on electronic traffic devices at pedestrian crossings. These later devices feature two icons images: a dynamic image of a WALKING MAN for GO or WALK and the image of a held-up HAND for STOP.

### SUMMARY OF THE INVENTION

Traffic signs are activated or turned on in an alternating sequence to alert pedestrians and motor vehicles when they can cross a respective street or thoroughfare, and to control the traffic flow. However, the present inventor has found that these icons could be used as images are also excellent advertising tools because they are virtually everywhere and therefore they are instantly recognizable by people of all ages, geographic location or economic status.

### BRIEF DESCRIPTION OF THE DRAWINGS

FIGS. 1-5 show various traffic signal devices, usually placed at pedestrian intersections for directing traffic;

FIGS. 6A, 6B and 7 shows the icon on a traffic sign modified to include an advertisement; and

FIG. 8 shows an image altered to include an icon in accordance with this invention.

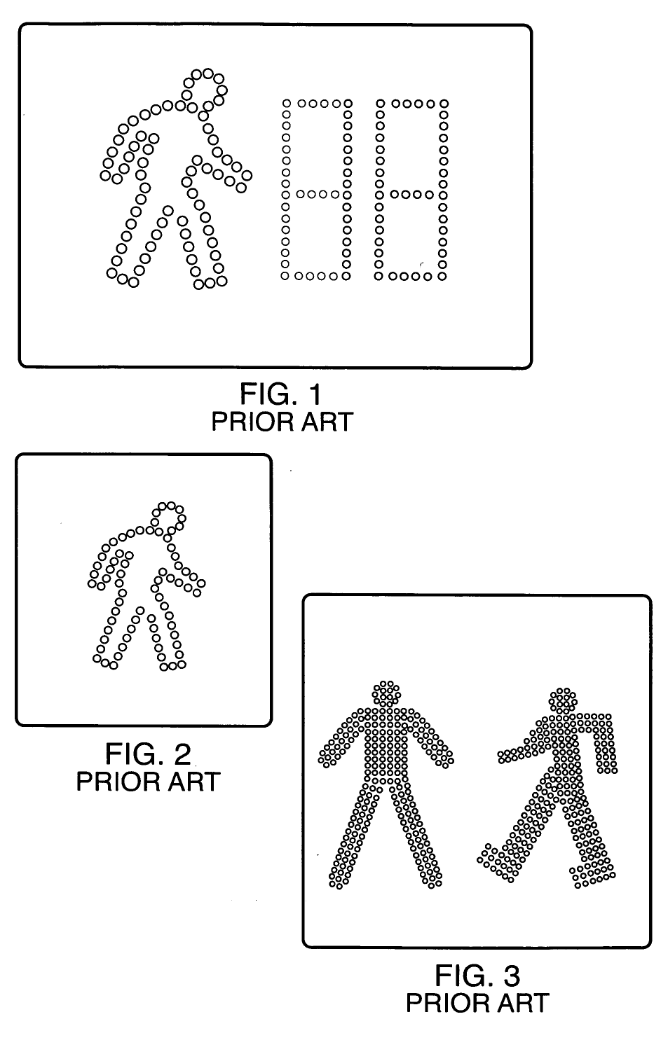

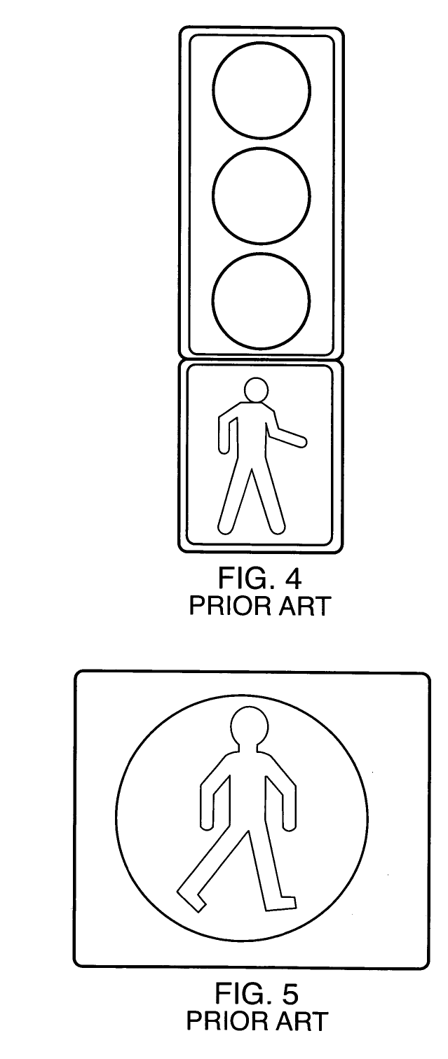

### DETAILED DESCRIPTION OF THE PREFERRED EMBODIMENT

In one advantageous embodiment, a traffic sign is adapted to provide advertisements using the HAND or the WALKING MAN icon used in traffic signal devices. This is particularly advantageous for the stopped traffic since the pedestrians and the occupants of motor vehicle can watch advertisement while they are waiting for the traffic signal to change. The advertisements could include symbols or graphics added or superimposed on the standard HAND and WALKING MAN icon and providing an associated message.

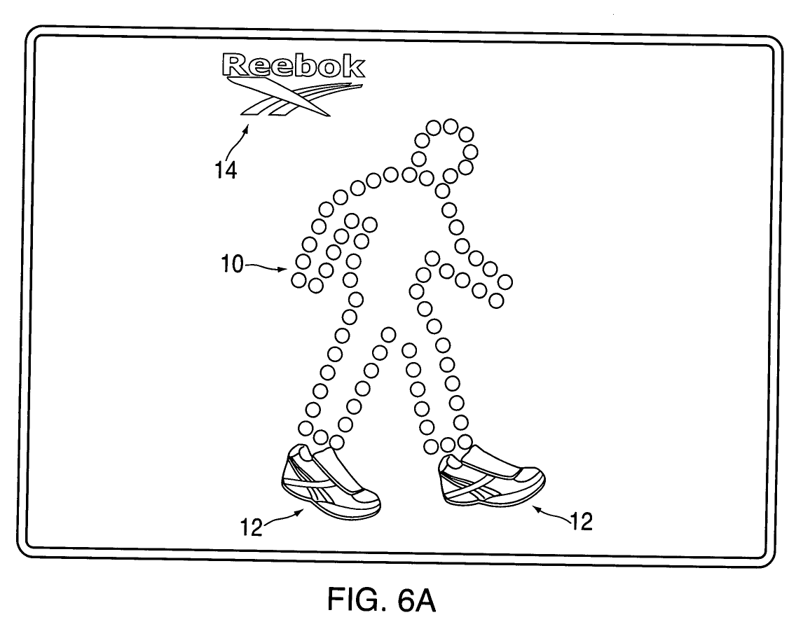

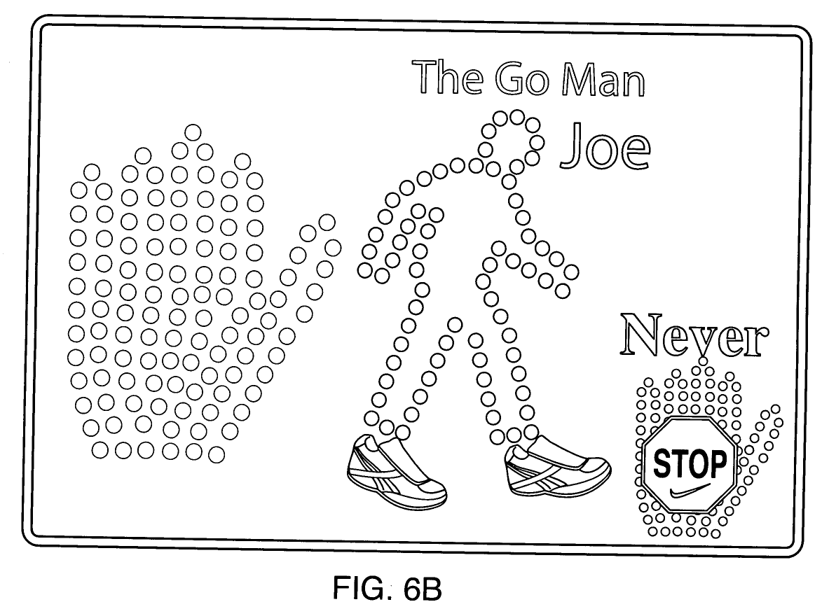

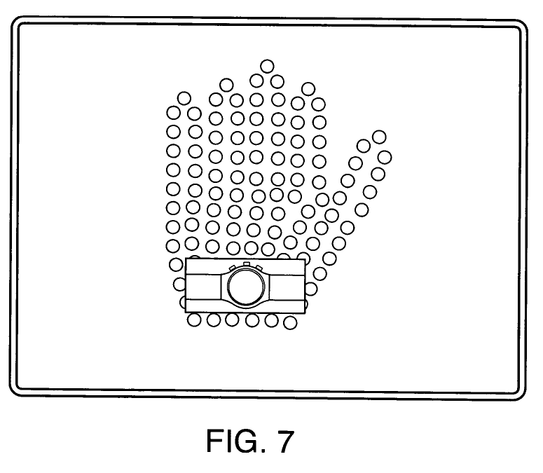

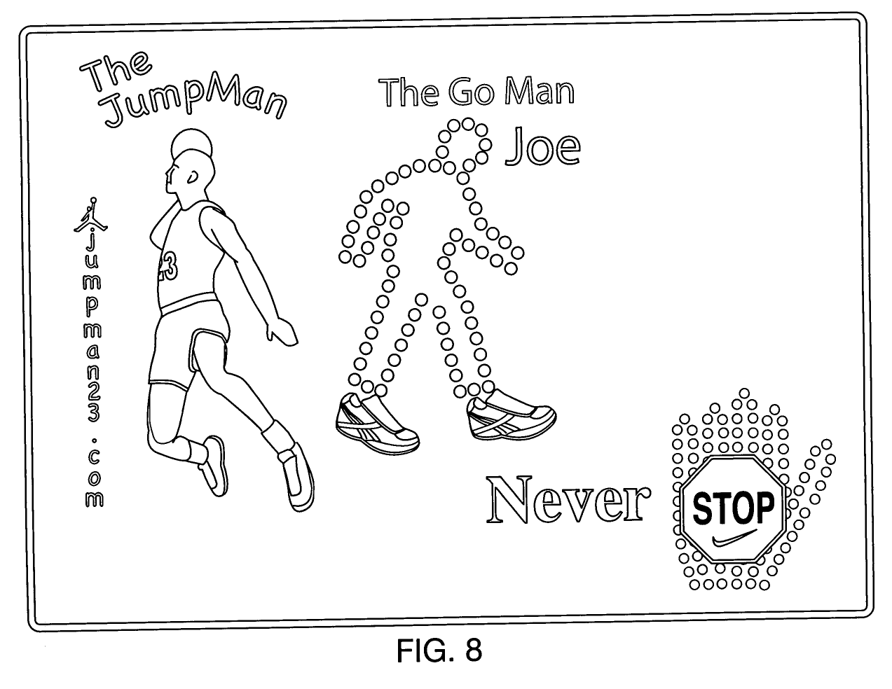

For example, the HAND icon may be adorned with a watch (See FIG. 7) from a particular manufacturer. Similarly, the WALKING MAN icon can also be altered to generate an advertisement or other message. For example, FIG. 6A shows an advertisement including the WALKING MAN icon adopted from a traffic sign but which has been modified to include sneakers of the brand being advertised. More specifically FIG. 6A shows an advertisement including a walking character 10, wearing sneakers 12 and the logo 14 of the sneakers 12. The advertisement is desirable because it associates a specific product (in this case, sneakers) with the walking man character that is normally only associated with a pedestrian traffic signal and inspires movement, action, dynamic personalities, a person on the GO. FIG. 6B shows a similar advertising sign with a traffic icon and a more dynamic picture of a person.

These messages may be part of the traffic sign itself, or an auxiliary screen may be provided for the advertising incorporating the hand or the walking man icons.

The hand and walking man icons may be used in a large variety of advertisements covering various goods and services, wherein the icons are semantically related therewith. For example, the walking man icon may be used to advertise walking shoes, apparel (including jogging suits, caps, attaché case etc.), beverages (man holding bottle), credit cards, portable electronics (cell phones, stereo equipment, batteries and so on. As discussed above, the walking man icon may also be used to suggest action, movement, dynamic personality, etc.

The hand icon may be used for advertising various products and services as well. For example, it may be used to advertise jewelry, cosmetics, nail polish and so on. The hand icon may also be used to suggest certain qualities of a product (e.g., a health drink) or service that the image of a hand may inspire, such as strength, well-being, friendship, competence, and so on.

Importantly, depending on the media, the image may be a still image for static or fixed advertisements such as the ones appearing on billboards, in magazines and newspapers, etc.). Alternatively, the hand icon and waling man icon can also be used motion-picture type advertisements shown on TV, movies, large screens in public spaces, and so on. The characters in these types of advertisements could be cartoon characters, animated figures or real actors dressed up in customs.

Numerous modifications may be made to the invention without departing from its scope as defined in the appended claims.

I claim:

1. A traffic device comprising:
a holder; and
an electronic sign supported by said holder, said sign displaying a traffic icon modified to provide advertisement information.

2. The traffic device of claim 1 wherein said sign is composed of a plurality of point sources.

3. A system for advertising goods and services, comprising:
a set of images including at least graphics, said images incorporating a traffic icon.

4. The system of claim 3 wherein said traffic icon consists of a plurality of point sources.

5. The system of claim 3 wherein said traffic icon is selected from the group consisting of a walking man and a hand icon.

6. The system of claim 3 wherein said images further include text.

7. The system of claim 3 wherein each image includes a representation of a product or service, and a semantically associated traffic icon.

8. The system of claim 3 wherein at least one image includes two traffic icons.

9. The system of claim 3 wherein said advertisement pertains to dynamic activities and the associated icon is the walking man icon.

10. The system of claim 10 wherein said advertisement is associated with sports activities.

11. A method of creating advertising for various products, comprising:
providing a plurality of images, each image including a traffic icon associated with the respect products.

12. The method of claim 11 wherein each image includes a representation of a person or product.

13. The method of claim 11 wherein each image includes text.

14. The method of claim 11 wherein said images are selected from at least one of a static image, a dynamic image and a cartoon image.

15. The method of claim 11 wherein said icons are selected from at least one of a hand icon and a walking man icon.

16. The method of claim 11 wherein said icon is superimposed over the representation of a product.
